(19) United States
(12) Patent Application Publication
(10) Pub. No.: US 2018/0240128 A1
(43) Pub. Date: Aug. 23, 2018

(54) SERVICE REQUEST MATCHING BASED ON PROVIDER COMPLIANCE STATE

(71) Applicant: Uber Technologies, Inc., San Francisco, CA (US)

(72) Inventors: Jeremiah Lu, Union City, CA (US); Yibing Shi, San Francisco, CA (US); Wu Kan, San Francisco, CA (US); Yichen Wang, San Franciscco, CA (US); Jun Ma, San Francisco, CA (US)

(21) Appl. No.: 15/900,124

(22) Filed: Feb. 20, 2018

Related U.S. Application Data
(60) Provisional application No. 62/461,211, filed on Feb. 20, 2017.

(51) Int. Cl. G06Q 30/00; G06Q 40/00; G06Q 10/06; G06Q 20/08; G06Q 50/30

(52) U.S. Cl. CPC G06Q 30/018; G06Q 40/12; G06Q 2240/00; G06Q 20/0855; G06Q 50/30; G06Q 10/063112

(57) ABSTRACT

A system operates to determine value of a compliance parameter, where the value of the compliance parameter reflects a compliance state of the provider with respect to a set of compliance rules. The selection of the service provider for service requests may be based in part on the value of the compliance parameter, and an attribute of individual service requests which is related to the value of the compliance parameter.

### RELATED APPLICATIONS

This application claims benefit of priority to Provisional U.S. Patent Application No. 62/461,211; filed Feb. 20, 2017; the aforementioned priority application being incorporated by reference in its entirety.

### BACKGROUND

Network-services exist to provide on-demand services, primarily by matching service providers with service requests. Numerous considerations are required for implementing on-demand services, based on geographic region, type of service provided, and other considerations.

### BRIEF DESCRIPTION OF THE DRAWINGS

FIG. 1 illustrates an example service arrangement system, according to one or more embodiments.

FIG. 2 illustrates an example method for matching service providers to service requests based on a compliance state of the individual service providers

FIG. 3 is a block diagram that illustrates a computer system upon which embodiments described herein may be implemented.

### DETAILED DESCRIPTION

A system operates to determine value of a compliance parameter, where the value of the compliance parameter reflects a compliance state of the provider with respect to a set of compliance rules. The selection of the service provider for service requests may be based in part on the value of the compliance parameter, and an attribute of individual service requests which is related to the value of the compliance parameter.

As used herein, a requester or provider device may include a mobile device, such as a wireless telephony and/or messaging device, including cellular smartphones, wearable electronic devices, laptop computers, tablet devices, and other devices which can provide network connectivity and processing resources for communicating with a network computer system over one or more networks.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

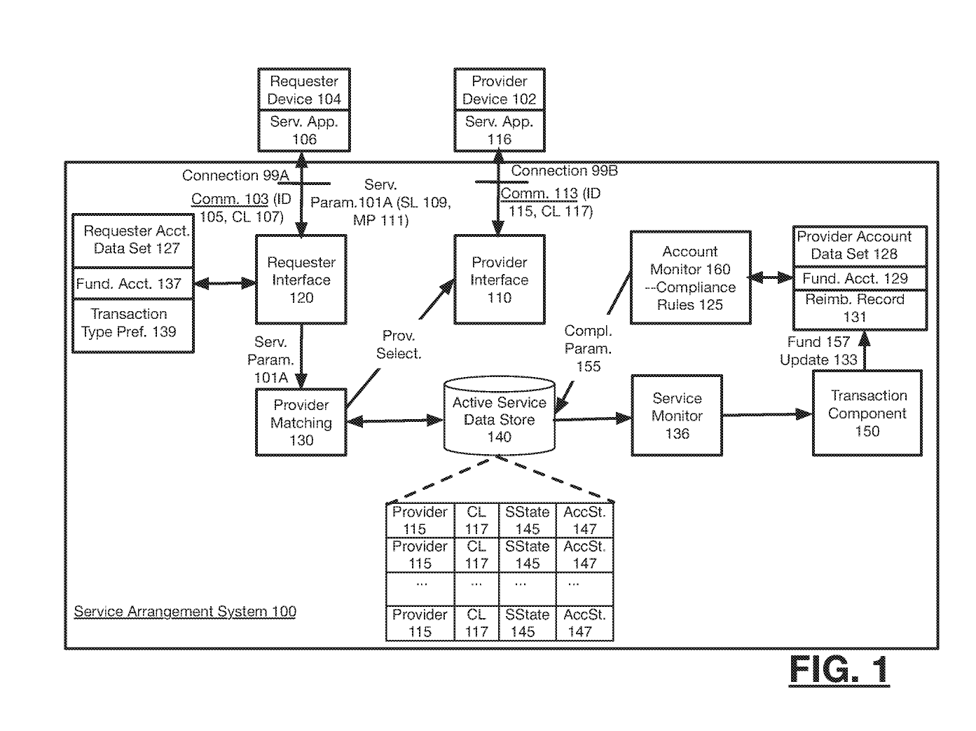

FIG. 1 illustrates an example service arrangement system, according to one or more embodiments. An example such as shown with FIG. 1 may be implemented using, for example, a server or a combination of servers, communicating with mobile computing devices carried by providers and requesters (e.g., customers) of an on-demand system. In variations, some or all the functionality described with the system 100 may be implemented using a distributed computing environment, such as provided by client computers and or mobile computing devices which communicate with a computer system or network service.

In an example, system 100 operates to provide a network service (e.g., on-demand transportation service), while determining a compliance state of individual service providers who access and use the network service. For example, the system 100 can determine when individual service providers are not in compliance with respect to a set of compliance rules that govern specific types of actions of the service provider. The system 100 can detect non-compliance of such rules, and further enforce individual service providers (e.g., influence behavior of a service provider) to become in compliance through implementation of logic which alters the manner in which system 100 is made available to the service provider. For example, the service provider may experience fewer matchings with service requests while the service provider is deemed to be in a state of non-compliance with respect to one or more compliance rules.

Some examples are illustrated in context of compliance rules which pertain to how a service provider accepts payment for service. In other variations, other types of compliance rules may be defined for a network service provided through system 100. The system 100 may monitor individual service providers for compliance using data communicated by corresponding provider devices, as well as other sources (e.g., requester devices).

With further reference to an example of FIG. 1, system 100 includes a provider device interface 110, a requester device interface 120, a provider selection component 130, an active service provider data store (“ASP data store 140”), a transaction component 150 and a provider account monitor 160. The system 100 may be implemented to arrange service providers for requesters, in connection with various types of services which may be performed by service providers. The service providers may correspond to individuals who perform services of a particular type, such as, for example, individuals who utilize vehicles to provide transport services (e.g., vehicle transport for requesters, package delivery, food delivery etc.). Similarly, the requesters may correspond to individuals who make service requests 101 from the system 100 for service providers to perform the service of a particular type. Among other functions, the system 100 operates to receive service requests from requesters (or customers), assign service providers to service requests based on criteria (e.g., relative location of service provider to service location, account status of service provider, etc.), and determine a service fee (e.g., transportation fare) for service requests which are completed.

In some examples, each requester operates a corresponding mobile computing device (“requester device 104”), on which a corresponding service application 106 is operated. When launched on the requester device 104, the service application 106 executes to establish a network connection 99A with the system 100, using one or more wireless networks. For example, a given requester device 104, as shown with FIG. 1, may utilize a combination of a Wi-Fi connection, cellular connection, and the Internet to connect to a server on which the system 100 is implemented. To establish the network connection 99A, the service application 106 sends a communication 103 that includes a requester device identifier 105 to the system 100. The requester device interface 120 represents a server process (or combination of processes) that receives the communication 103, and associates the requester device identifier 105 with a requester account data set 127. The requester account data set 127 may include, for example, a funding account identifier 137 (e.g., credit card number) and information that enables the system 100 to obtain authorization for service fees which are incurred through the requester's use of services, arranged through system 100. In some examples, requester device 104 can make a service payment for a service received through system 100, by pre-authorizing the system 100 to use the stored funding account identifier 127 to obtain funds from the requester's account. For some requesters, the requester account data set 127 may not include a stored funding account identifier 137, but rather may include information such as a preference 139 or setting indicating the requester will pay for services using a payment mechanism that bypasses system 100. In some examples, the requester can make a direct payment to the service provider, using, for example, cash, an alternative instrument of value (e.g., gift card), an alternative (e.g., third-party) payment authorization service for another user funding account, or digital wallet (e.g., digital currency carried on or made accessible through the user device).

To utilize the system 100, each service provider may also operate a corresponding mobile computing device (“provider computing device 102”) on which a provider service application 116 is operated. Each service provider may be registered with the system 100, such that each provider has an account with the system 100. To register with the system 100, individual providers may be required to satisfy a list of requirements, such as (i) demonstrating ability or skill to perform services that may be requested of the drivers, (ii) access to a vehicle and/or other equipment which may be required for the type of service the service provider can provide, and/or (iii) historical requirements relevant to the determination of whether the service provider is competent and trustworthy.

Once registered, the service providers may operate the service application 116 to avail themselves to the system 100, which in turn matches them to service request 101 that are received by the system 100 from requesters. In some examples, a service provider may operate the service application 116 on the provider device 102 to toggle a graphic user interface (“GUI”) between a representative state of on-duty and off-duty. When on-duty, the service application 116 may execute on the provider device 102 to transmit a device identifier 105 for the provider device, along with the current location 107 of the service provider device 102.

The provider device interface 110 may represent one or more server processes which operate to establish a network connection 99B with the provider device 102. When the provider device 102 is on-duty, the provider device interface 110 can continuously or repeatedly receive communications 113 from the provider device 102, indicating a provider device identifier 115 and a current location 117 of the provider device 102 (and thus the provider vehicle). The provider device interface 110 may communicate the provider device identifier 115 and the provider's current location 107 to the ASP data store 140. The provider device interface 110 may also repeatedly update the ASP data store 140 in regards to the current location 117 of the service provider based on the communications 113 received from the provider device 102 while the provider is on-duty.

On the requester device 104, the service application 106 can be implemented to enable the service requester to select a service type (e.g., type of transport service, type of vehicle) as well as one or more service request parameters 101A, in connection with a corresponding service request 101 that is communicated over the network connection 99A to the system 100. By way of example, the service request parameters 101A can specify a service location 109 (e.g., pickup or drop-off location) and a mode of payment 111 (e.g., cash, credit card, etc.). In some variations, the determination of the service request parameters 101A may be at least partially automated. For example, the service application 106 may execute to determine the current location 107 of the requester device (e.g., using a Global Positioning system (“GPS) or other location aware resource on the requester device 104), and the current location 107 of the requester device 104 at the time the service request 101 is generated may be used for at least a part of the service location (e.g., pickup location). As an addition or variation, the requester device interface 120 may identify a preference of the requester from the requester's account data set 127. For example, the requester's account data set 127 may identify the requester's preferred or likely mode of payment 111, based on past transactions and/or stated preference.

The provider selection component 130 may utilize the service request parameters 101A to match a corresponding service request 101 with an available service provider. In some examples, the provider selection component 130 may interface with the ASP data store 140, which maintains a set of active service parameters 144 for each service provider. As described in greater detail, the active service provider parameters 144 may associate the identifier 115 of each service provider with that service provider's current location 117 and service state 145.

The provider selection component 130 may interface with the ASP data store 140 to select a service provider for each service request 101, based on selection criteria that is determined from the service parameters 101A, such as the service location 109 (e.g., pickup location), and the proximity of service providers (e.g., based on the service provider's current location 117) to the service location 109.

Additionally, the provider selection component 130 may select the service provider based on an availability of individual service providers at either a current instance, or during an upcoming duration of time during which the service provider will become available. In particular, some examples provide that the availability of individual service providers may be based on a service state 145 of the individual service providers. For example, when a given service provider is identified as being on-duty, the ASP data store 140 identifies the service state 145 of that service provider as being available. When the provider selection component 130 assigns the service provider to a service request 101, the provider selection component 130 may update the service status 145 of the particular service provider to “on-service”. For purpose of matching service provider to service request 101, the provider selection component 130 may identify those service providers who are on-duty and not “on-service” as being available.

In variations, additional layers of granularity may be used with respect to the service status 145 of the individual providers, in order to determine the pool of available service providers for a given service request 101. In some examples, the service state 145 of individual providers may include one or more designations representing, for example, “en route” (meaning the service provider is traveling to the service location), and/or “nearing completion” (meaning the service provider is expected to finish a current service requests within a threshold time period that enables the service provider to be selected for a next service request). For example, the provider selection component 130 may also identify those service providers who are “on-service”, but whom are also scheduled to complete their current service request within a given time threshold, as being available for the current service request 101.

Numerous variations to determining availability a service provider may be implemented, based in part on the type of service. For example, system 100 may enable the service provider to provide a transport pool, in which transport services are provided to multiple requesters at one time. In such implementations, the availability of a given service provider may be based on whether the given service provider is currently assigned to a maximum number of service requests, or whether the service provider will be available to handle an additional service request within an upcoming threshold period of time. Still further, the provider selection component 130 may select service providers by first determining a candidate set of service providers, and then implementing a process to match a service provider from the candidate set to individual transport requests 101 that are current and unassigned.

According to some examples, provider selection component 130 utilizes selection criteria that also accounts for a state of compliance by individual service providers with respect to a set of compliance rules 125. In particular, the system 100 may impose compliance rules 125 on service providers in connection with account activities which system 100 may require service providers to perform. The account activities may be required of service providers in order to, for example, account for specific types of transactions, and/or comply with audit requirements that may be required based on geographic region or service type. For example, some geographic regions may tend to have users who pay in cash rather than through account authorization (e.g., user stores account information for a funding account, such as a credit card or debit card, and then authorizes payment for services received using the stored account information). In such geographic regions, the system 100 can assign service providers to service request, and further communicate the fare amount of each completed service request to both service provider and requester upon completion of the service request. In such examples, the service provider may have one or more follow-on obligations that arise from the service provider receiving cash payment. By way of example, the following obligations may include: (i) depositing the cash payment at a designated location, (ii) generating receipts for the cash transactions, and providing copies of the receipts to the system 100, and/or (iii) forwarding a portion of the fare amounts received for the cash transactions to the system 100, corresponding to, for example, a service charge of system 100.

According to some examples, the ASP data store 140 maintains an active data store, which maintains active service provider parameters corresponding to (i) the service provider identifier 115, identifying each on-duty service provider, (ii) the current location 117 of each service provider, (iii) the service state 145 of each service provider, (e.g., on-service, available for service assignment, nearing availability for service assignment), and (iv) an account status parameter 147, indicating whether the service provider is compliant with the set of compliance rules 125. In some examples, the identification of active service providers (e.g., service providers who are on duty), as well as their respective current locations 117, is updated by the provider device interface 110, based on communications received from the respective provider devices 102. Additionally, in some examples, the service state field 145 may updated by the provider selection component 130 when service requests 101 are matched to the service provider. The provider selection component 130 may indicate when, for example, the service provider is on-route to a service location, when the service provider is on-service, and/or when the service provider is nearing completion of an assigned service request. Still further, in some examples, the provider selection component 130 can also associate the provider with an assigned service request 101 and/or corresponding requester, until when the service request 101 is complete.

A service monitor 136 may monitor the ASP data store 140 to determine when a service provider completes an assigned service request. In some examples, the service provider generates (via operation of the service application 116 of the provider device 102) a termination communication to indicate that the service was completed. In variations, the service monitor 136 can determine when an assigned service request is complete based at least in part on the communications 105 received from the requester device 104 (e.g., comparison of the location of the requester device 104 and the provider device 102).

In an example, the transaction component 150 determines the transaction amount (e.g., fare amount for transport services) based on a variety of parameters, including the distance traveled and/or the duration of the transport. In variations, the transaction component 150 determines the transaction amount before the service provider reaches the destination. For example, the transaction component 150 can determine the transaction amount while the requester is in the vehicle (e.g., based on a comparison of location data of the respective devices of the service provider and the requester). Still further, in other variations, the transaction component 150 can be determined in advance of the requester entering a vehicle, such as at a time when the requester first requests transport using the requester device.

In some variations, the system 100 makes one or multiple determinations as to when the service request 101 is complete, and/or whether the requester made direct payment for a completed transport request 101. The determination(s) can be made using, for example, input from the provider device 102 or requester device 104. In other variations, the determination(s) can made through inference, such as through observing location data (or other activity data indicators) transmitted from one or both of the provider and requester devices 102, 104. In some examples, the system 100 may implement processes on the respective provider and/or requester devices, in order to extract location data and/or obtain user input to confirm one or more of (i) completion of the service request, (ii) the transaction amount, or (iii) direct payment of the transaction amount. By way of example, the service monitor 136 can monitor the ASP data store 140 to detect user-input, location data or other activity data that is indicative of the determinations.

Accordingly, when the service request 101 is determined to have completed, the transaction component 150 determines the transaction amount (e.g., fare amount for transport services) for the service provided to the requester, and the transaction amount can be communicated to provider and/or requester, using each of the respective provider or requester devices 102, 104. At a given time interval when the service provider is deemed to be nearing, or at a destination of the service request, system 100 can monitor the provider device and/or the requester device, to determine when, for example, the requester and provider separate from one another. This determination can be made by comparing the location data from the requester device and/or provider device to detect when a proximity between the two devices exceeds a threshold indicator for locating the requester and provider in the same vehicle. In this manner, the transaction component 150 can infer when direct payment was made by the requester. As an addition or variation, the determination of direct payment can be made (or confirmed) by messaging the respective requester and/or provider device to request confirmation of payment and fare amount.

The transaction component 150 may determine the transaction amount based on, for example, the service parameters 101A. For example, for a transport service, the transaction component 150 may determine the transaction amount based on the pickup location, the drop-off location, and/or the time of travel, as well as the service type (e.g., type of vehicle, pooled transport versus individual transport, etc.). In some examples, the requester pre-enables account authorization transactions (e.g., requester submits information from a credit card), and the transaction component 150 charges the funding account of the requester for the service fee. The transaction component 150 may also fund 157 a funding account 129 of the service provider for a portion of the service fee, with the system 100 collecting a portion of the transacted service fee as a service charge.

In some examples, the system 100 enables multiple types of transaction types by which the requester can make payment for the requester service, including, for example, direct payment transactions (e.g., cash transactions). In such transactions, the requester makes payment directly to the service provider for a completed service request. For example, the requester may pay the service provider with cash, gift card, or by account authorization that is processed directly by the service provider. For such transaction types, the service monitor 136 may record the completion of the service request, and the transaction component 150 may determine the service fee for the service provided by the service provider.

Still further, in some examples, the transaction component 150 may fund the service provider's funding account 129 when the requester makes a service payment, using an account authorization mechanism provided through system 100 (e.g., pre-authorized funding account, using stored credit card account number).

When the requester makes a direct payment to the service provider, the transaction component 150 may record the transaction amount with the provider's account data set 128. The account monitor 160 may then monitor the service provider's account data set 128 to determine when the service provider performs a required activity with regards to the direct payment, in accordance with the set of compliance rules 125. In one implementation, the account monitor 160 monitors for the service provider to deposit the service charge, representing the portion of the total service fee owed to system 100 for the transaction in which the service provider received the direct payment from the requester.

To monitor for compliance, the system 100 may include one or more processes, represented by account monitor 160, which monitor each service provider's account data set 128, as well as other data such as the service provider's profile information, to determine whether each service provider is in compliance with the compliance rules 125. When the compliance rules 125 require the service provider to perform an activity as a result of, for example, the transaction type used by a requester (e.g., requester makes cash payment), the account monitor 160 can monitor the service provider's account data set 128 to determine whether the service provider performed the required activity.

By way of example, the service provider's account data set 128 may identify a reimbursement record 131 of reimbursement funds which are electronically deposited by the service provider for transfer to a funding account of the system 100. As an addition or variation, the reimbursement record 131 may identify reimbursement funds which the service provider transferred or had credited back to system 100, as reimbursement for service charges in which the requester made cash or other form of direct payment to the service provider. In an example, the compliance rules 125 may set the percentage which the service provider is to have transferred to the system's funding account, based on the portion of the total fares which the service provider collected over a given duration of time. In variations, the compliance rules 125 may set the percentage which the service provider is to have transferred to the system's funding account, based on the portion of the fares charged by 100 for completed service requests in which the transaction payment was of a particular type, such as a cash payment or direct payment from the requester to the service provider.

In some examples, the service provider's account data set 128 may reflect information provided with the funding account of the service provider, as well as information that is specific to the individual service provider from the funding account of system 100. The account monitor 160 can monitor the service provider's account data set 128, and/or the funding account 152 of the system 100, to determine, for example, whether the service provider has reimbursed funding account 152 of the system 100 for the portion of the fares received by the service provider through cash-type transactions.

Based on the service provider's account data set 128, the account monitor 160 can determine a compliance state 155 of the service provider with respect to the set of compliance rules. In some examples, the compliance state 155 can be binary (e.g., the service provider is in compliance, or not in compliance), trinary (e.g., the service provider is in compliance, not in compliance, or not in compliance but in grace-period), or set within a numeric range to reflect a score or other measure of non-compliance. In variations, the compliance state 155 can represent an alternative magnitude of non-compliance, such as a number of days in which the service provider has been non-compliant, an amount of funds owed by the service provider, a number of transactions which the service provider has yet to perform required activity on, etc.

The determination by the account monitor 160 of the compliance state 155 can also be based on a threshold value or parameter. For example, a service provider may be deemed to be not in compliance if the amount owed by the service provider for cash-type transactions (e.g., requester pays service provider in cash once the service is completed) exceeds a set threshold value (e.g., fixed amount, proportionate amount based on total owed, etc.). In a variation, the service provider may be deemed to not be compliant if the amount owed by the service provider is aged beyond a threshold duration of time.

The account status parameter 147 of the ASP data store 140 may reflect the compliance state 155 of the service provider. The account monitor 160 can update the ASP data store 140 when, for example, the compliance state 155 of the service provider is changed, or when the compliance state of the service provider indicates the service provider is not in compliance.

In selecting a given service provider for service requests, the provider selection component 130 can factor multiple service parameters 144, including the account status parameter 147. The account status parameter 147 can be used to exclude a service provider from the selection pool based on transaction type, or other selection criterion. As an alternative or variation, the account status parameter 147 can be used to weight the selection of the service provider for or against service requests which are of a particular transaction type (e.g., cash versus card instrument or account authorization).

In one implementation, if the account status parameter 147 of a given service provider indicates “not compliant” (or some value of non-compliance), the provider selection component 130 may exclude that service provider from the selection pool for select types of service requests. In some examples, the provider selection component 130 may exclude the service provider from service requests which are of a particular transaction type, such as cash (or direct) payment transactions. In such examples, the provider selection component 130 may determine (or predict) the transaction type (e.g., cash payment versus funding account authorization) for incoming service requests 101 based on input from the requester (e.g., the requester may specify that payment for services rendered will be in cash), a stored preference of the requester (e.g., based on profile information associated with the requester), and/or historical information about the requester (e.g., requester paid for several prior transactions using cash).

In one implementation, the provider selection component 130 may interface with the ASP data store 140 to determine a pool of available service providers from which the service provider for the service request is selected. In determining the pool of available service providers for a service request 101 that is deemed to be a cash payment transaction, the provider selection component 130 may alter the provider selection process to exclude those service providers who have corresponding account status parameters 147 that indicate non-compliance with respect to prior cash payment transactions. In this way, the provider selection component 130 can enable for example, the account monitor 160 to enforce the service provider's compliance with the compliance rules 125. For example, the account monitor 160 may send a message to the service provider, indicating the service provider will receive fewer service assignments by virtue of being removed from the selection pool for service requests which are deemed to be cash type service transactions.

In variations, the transaction component 150 may also enforce the compliance rules 125 by adjusting the service charge (or the portion of the service fee which the requester pays for receiving the service from the service provider) for subsequent assignments given to the provider, until the service provider is in compliance with the set of compliance rules 125. For example, the provider selection component 130 may limit selection of a non-compliant service provider (e.g., based on the account status parameter 147) to transaction types which are deemed to be account authorizations (e.g., requester includes information for funding account with requester profile). The transaction component 150 may withdraw the authorized amount for the completed service request from the requester's funding account, then use some or all of the withdrawn amount to pay the delinquent service charge which is owed by the service provider for prior cash transactions. The reimbursement record 131 of the service provider's account data set 128 may then be updated 133 to reflect the reimbursement which was completed through the transaction component 150.

In variations, the provider selection component 130 may alter the provider selection process to prioritize or weight (i) against selection of a non-compliant provider with respect to transaction types that can worsen the non-compliance of the provider, and/or (ii) for selection of a non-compliant provider with respect to transaction types that can cure or lessen the underlying deficiency of the non-compliance.

Still further, in some examples, the provider selection component 130 may alter the provider selection process for non-compliant providers, subject to limits of a selection or optimization objective. For example, the exclusion of negative weighting of non-compliant providers with respect to the available pool for given service requests may be subject to an objective in which the wait time for the requester of the service requester is not increased by a threshold amount. In some variations, the provider selection component 130 handles multiple service requests concurrently, with an optimization object that includes minimizing an average wait time for service providers to each the service location 109 (e.g., pickup location) of the corresponding requesters. In such examples, the exclusion or negative weighting of service non-compliant service providers may be subject to a threshold negative impact with respect to the optimization objective. For example, the exclusion of the non-compliant service provider may be subject to the average wait time for open service requests 101 to not be increased by a threshold amount (e.g., one minute).

In some examples, the provider selection component 130 alters the provider selection process for providers based on a type or severity of the non-compliance (e.g., amount owed, duration of non-compliance, number of transactions which the service provider failed one of the compliance rules 125, etc.). For example, the provider selection component 130 may exclude a non-compliant service provider from service requests which are deemed to be cash transactions when a degree of non-compliance is deemed severe (e.g., exceeding a severity threshold by amount, duration, etc.), while the provider selection component 130 may weight against matching the non-compliant service provider with such service requests when the degree of non-compliance is deemed moderate.

Methodology

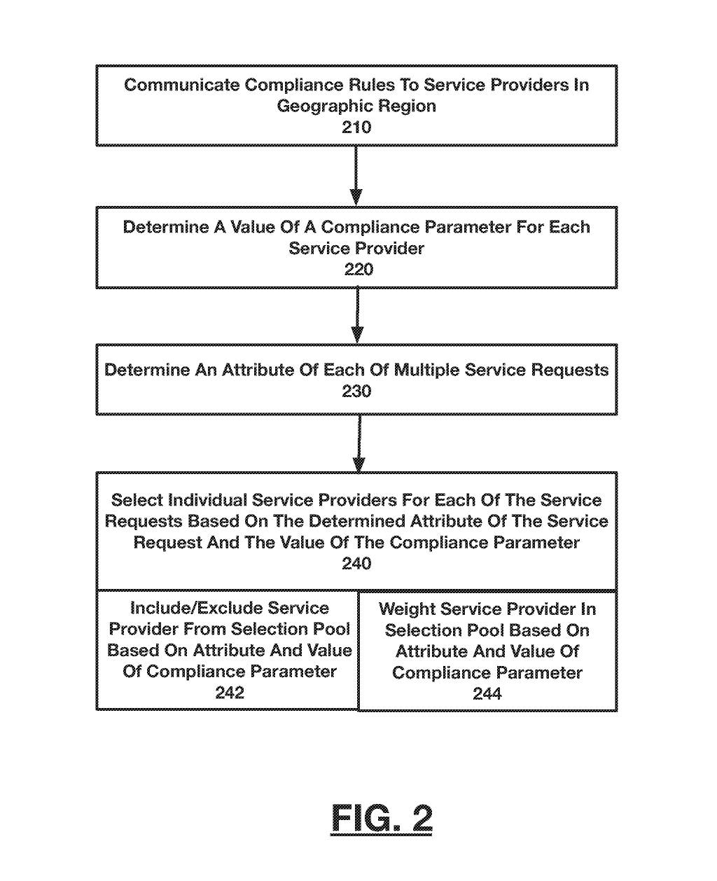

FIG. 2 illustrates an example method for matching service providers to service requests based on a compliance state of the individual service providers. In describing an example of FIG. 2, reference may be made to numerals of FIG. 1 for purpose of illustrating suitable components or elements for implementing a step or sub-step being described.

With reference to FIG. 2, a set of compliance rules 125 may be communicated to individual service providers of a given geographic region (210). The compliance rules 125 may be communicated to service providers as part of, for example, an on-boarding process, or through electronic messages (e.g., via application messages communicated through the service application 116). The compliance rules 125 may be specific to the geographic region, as services arranged through the system 100 may differ based on the culture, rules and business needs of a given geographic region. As described with various examples, the compliance rules 125 may identify accounting functions which individual service providers are required to perform for the system 100 in response to certain conditions or events. For example, the compliance rules 125 may identify accounting functions which service providers are to perform when the customer (or requester) provides a direct (e.g., cash) payment to the service provider.

The system 100 may determine a value of a compliance parameter 155 for each active service provider in a given geographic region (220). Depending on implementation, the compliance parameter 155 may be binary (e.g., “compliant” or “non-compliant”), trinary, or based on a numeric range that indicates a type or severity of non-compliance. In examples in which an accounting function required from a service provider is to provide reimbursement (e.g., to system 100 for service charges which were not deducted for the service fee as a result of the customer paying cash), the value of the compliance parameter 155 can indicate an amount in which the service provider is in arrears. The value of the compliance parameter may also be based on one or more thresholds, such that the service provider is deemed compliant unless the amount in arrears exceeds a threshold amount and/or past due duration.

In a given period of time, the system 100 can receive multiple service requests, and for each service request, the system 100 may determine an attribute which relates to a compliance rule (230). In some examples, the attribute of the individual service requests corresponds to a mode of payment, such as credit account authorization or cash payment. For example, in some service requests 101, the customer may specify, or have preference to use a pre-stored credit card, in which case the system 100 charges payment for the service provided and compensates the service provider a proportion of the total service fee charged to the customer. For other service requests, the system 100 may determine that the transaction type that is to be used is cash payment. The determination may be based on, for example, a specified preference of the requester (e.g., made at the time of the service request), or based on a historical record or stored preference of the customer.

The system 100 may select individual service providers for each of the multiple service requests based at least in part on the determined attribute of each service request, as well as the value of the compliance parameter for one or more of the plurality of service providers (240). In an example in which the attribute corresponds to the mode of payment, the compliance parameter may reflect whether individual service providers are in compliance with the compliance rules 125. For example, the compliance parameter 155 may indicate whether the service provider is in arrears with respect to reimbursing the system 100 for service charges, in connection with previous transactions in which the service provider received cash payment from customers.

In some examples, the selection of service provider (e.g., by provider selection component 130) for each of the multiple service requests can be through exclusion and/or inclusion of the service provider for service requests based on the related attribute (e.g., mode of payment) (242). For example, in selecting service providers for service requests, the system 100 may (i) exclude non-compliant service providers (e.g., those in arrears with respect to reimbursement to system 100) from inclusion in the pool of service providers from which selection can be made, when the mode of payment of the service request is direct or cash; and (ii) include the non-compliant service providers in the pool of service providers from which selection can be made when the mode of payment for the services is an authorized account transaction conducted through the system 100. In such examples, the system 100 may match non-compliant service providers with service requests 101 that include a mode of payment attribute that reflects an account authorization, processed through the system 100. In some variations, the system 100 may also process the authorization payments made through the system 100 to collect on the amounts which the service provider is in arrears and/or the current service charge (so as to prevent the service provider from being further in arrears).

In variations, the compliance state of the service provider may weight the selection of the service provider for or against service requests, based on the related attribute (e.g., mode of payment of the service request) (244). For example, a non-compliant service provider may be negatively weighted to make selection of the service provider less likely for service requests which are deemed to be cash or direct modes of payment.

Hardware Diagrams

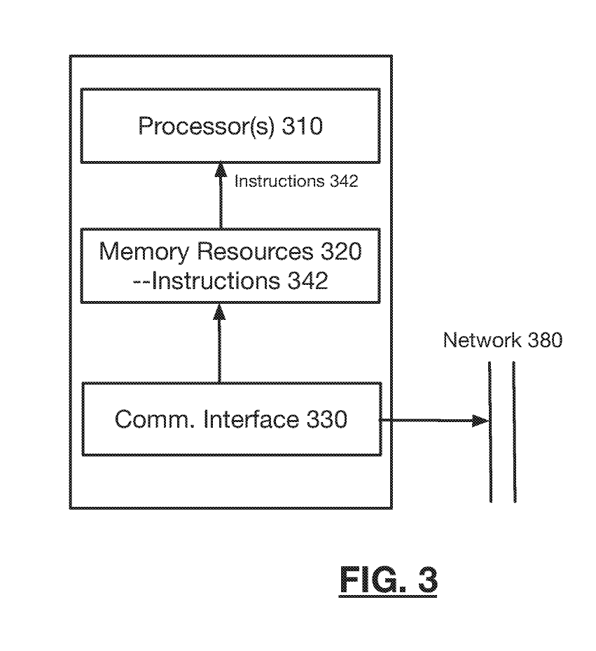

FIG. 3 is a block diagram that illustrates a computer system upon which embodiments described herein may be implemented. For example, in the context of FIG. 1, the service arrangement system 100 may be implemented using a computer system such as described by FIG. 3. The system 100 may alternatively be implemented using a distributed or combined set of multiple computer systems, as described by an example of FIG. 3.

In one implementation, a computer system 300 includes one or more processors 310, memory resources 320 (e.g., a main memory, a read only memory (ROM), random access memory (RAM), mass storage, etc.) and a communication interface 330. The memory resources 320 may store instructions, as well as temporary variables or other intermediate information that is generated during execution of instructions by the one or more processor 310. In one implementation, at least one processor 310 accesses the memory resources to execute instructions 342 for implementing the system 100 of FIG. 1. Likewise, at least one processor 310 accesses the memory resources to execute instructions 342 in implementing a method such as described with an example of FIG. 2.

The communication interface 330 can enable the computer system 300 to communicate with one or more networks 380 (e.g., cellular network) through use of the network link (wireless or wireline). Using the network link, the computer system 300 can communicate with one or more other computing devices and/or one or more other servers or data centers. By way of example and with reference to an example of FIG. 1, the computer system 300 can establish network connections 99A and 99B respectively with each of the provider device 102 and the requester device 104.

The computer system 300 can also include a display device, such as a cathode ray tube (CRT), an LCD monitor, or a television set, for example, for displaying graphics and information to a user. One or more input mechanisms, such as a keyboard that includes alphanumeric keys and other keys, can be coupled to the computer system 300 for communicating information and command selections to the processor 310. Other non-limiting, illustrative examples of input mechanisms include a mouse, a trackball, touch-sensitive screen, or cursor direction keys for communicating direction information and command selections to at least one processor 310 and for controlling cursor movement on the display.

Examples described herein are related to the use of the computer system 300 for implementing the techniques described herein. According to one embodiment, those techniques are performed by the computer system 300 in response to the one or more processors 310 executing one or more sequences of one or more instructions contained in the memory resources 320. Such instructions may be read into the memory resources 320 from another machine-readable medium, such as a storage device. Execution of the sequences of instructions contained in the memory resources 320 causes the one or more processors 310 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer system comprising:
a memory to store instructions;
one or more processors that execute the instructions to:
determine, for each active service provider in a given geographic region over a given duration of time, a value of a compliance parameter, the value of the compliance parameter defining a compliance state of the provider with respect to a set of compliance rules;
receive, during the given duration of time, a plurality of service requests; and
for each of the plurality of service requests, determine an attribute of the service request which relates to one or more compliance rules of the set, and select individual service providers to service requests based at least in part on the determined attribute of the service request and the value of the compliance parameter for one or more of the plurality of service providers.

2. The computer system of claim 1, wherein the one or more processors:
determine a current location of each service provider in the plurality of service providers repeatedly, over the given duration of time;
determine a service location for each of the plurality of service requests; and
wherein the one or more processors select, for each of the plurality of service requests, individual service providers based at least in part on the service location and the current location of one or more of the plurality of service providers when the service request is received.

3. The computer system of claim 1, wherein the one or more processors:
determine the attribute of one or more of the plurality of service requests based on a historical record of a corresponding user who made that service request.

4. The computer system of claim 1, wherein the attribute corresponds to a mode of payment that the requester is to use for payment of receiving the service.

5. The computer system of claim 1, wherein the set of compliance rules include one or more rules that provide for each of the plurality of service providers to perform an accounting function in response to a corresponding event or condition.

6. The computer system of claim 1, wherein the corresponding event or condition includes a customer having made direct payment to the service provider of a service fee for receiving a service from the service provider, and wherein the accounting function corresponds to the service provider having reimbursed a portion of the service fee corresponding to a service charge to a third-party account.

7. The computer system of claim 1, wherein the one or more processors select individual service providers for select service requests by excluding a service provider, for which the value of the compliance parameter is one of non-compliance, from a pool of service providers from which selection is made for the service request.

8. The computer system of claim 1, wherein the one or more processors select individual service providers for select service requests by negatively weighting a service provider, for which the value of the compliance parameter is one of non-compliance, when the service provider is included in a pool of service providers from which selection is made for the service request.

9. A non-transitory computer-readable medium that stores instructions, which when executed by one or more processors of a computer system, cause the computer system to perform operations that include:
determine, for each active service provider in a given geographic region over a given duration of time, a value of a compliance parameter, the value of the compliance parameter defining a compliance state of the provider with respect to a set of compliance rules;
receive, during the given duration of time, a plurality of service requests; and
for each of the plurality of service requests, determine an attribute of the service request which relates to one or more compliance rules of the set, and select individual service providers to service requests based at least in part on the determined attribute of the service request and the value of the compliance parameter for one or more of the plurality of service providers.

10. The non-transitory computer-readable medium of claim 9, wherein the one or more processors:
determine a current location of each service provider in the plurality of service providers repeatedly, over the given duration of time;
determine a service location for each of the plurality of service requests; and
wherein the one or more processors select, for each of the plurality of service requests, individual service providers based at least in part on the service location and the current location of one or more of the plurality of service providers when the service request is received.

11. The non-transitory computer-readable medium of claim 9, wherein the one or more processors:
determine the attribute of one or more of the plurality of service requests based on a historical record of a corresponding user who made that service request.

12. The non-transitory computer-readable medium of claim 9, wherein the attribute corresponds to a mode of payment that the requester is to use for payment of receiving the service.

13. The non-transitory computer-readable medium of claim 9, wherein the set of compliance rules include one or more rules that provide for each of the plurality of service providers to perform an accounting function in response to a corresponding event or condition.

14. The non-transitory computer-readable medium of claim 9, wherein the corresponding event or condition includes a customer having made direct payment to the service provider of a service fee for receiving a service from the service provider, and wherein the accounting function corresponds to the service provider having reimbursed a portion of the service fee corresponding to a service charge to a third-party account.

15. The non-transitory computer-readable medium of claim 9, wherein the one or more processors select individual service providers for select service requests by excluding a service provider, for which the value of the compliance parameter is one of non-compliance, from a pool of service providers from which selection is made for the service request.

16. The non-transitory computer-readable medium of claim 9, wherein the one or more processors select individual service providers for select service requests by negatively weighting a service provider, for which the value of the compliance parameter is one of non-compliance, when the service provider is included in a pool of service providers from which selection is made for the service request.

17. A method for operating a network computer system, the method being implemented by one or more processors of the network computer system and comprising:
determine, for each active service provider in a given geographic region over a given duration of time, a value of a compliance parameter, the value of the compliance parameter defining a compliance state of the provider with respect to a set of compliance rules;
receive, during the given duration of time, a plurality of service requests; and
for each of the plurality of service requests,
determining an attribute of the service request which relates to one or more compliance rules of the set, and
selecting individual service providers to service requests based at least in part on the determined attribute of the service request and the value of the compliance parameter for one or more of the plurality of service providers.

18. The method of claim 17, further comprising:
determining a current location of each service provider in the plurality of service providers repeatedly, over the given duration of time;
determining a service location for each of the plurality of service requests; and
wherein the one or more processors select, for each of the plurality of service requests, individual service providers based at least in part on the service location and the current location of one or more of the plurality of service providers when the service request is received.

19. The method of claim 17, wherein determining the attribute of one or more of the plurality of service requests is based on a historical record of a corresponding user who made that service request.

20. The method of claim 19, wherein the attribute corresponds to a mode of payment that the requester is to use for payment of receiving the service.
